(19) United States
(12) Patent Application Publication
(10) Pub. No.: US 2012/0062434 A1
(43) Pub. Date: Mar. 15, 2012

(54) ANTENNA USING A REACTIVE ELEMENT

(75) Inventors: Hyeong-Dong Kim, Seoul (KR); Hyeng-Cheul Choi, Seoul (KR); Shin-Hyung Jeon, Seoul (KR); Jung-Hwan Yeom, Seoul (KR); Oul Cho, Seoul (KR); Seung-Woo Kim, Gunpo (KR)

(73) Assignee: Industry-University Cooperation Foundation Hanyang University, Seoul (KR)

(21) Appl. No.: 13/240,653

(22) Filed: Sep. 22, 2011

Related U.S. Application Data
(63) Continuation of application No. PCT/KR2009/006308, filed on Oct. 29, 2009.

(30) Foreign Application Priority Data
Mar. 23, 2009 (KR) 10-2009-0024654
May 15, 2009 (KR) 10-2009-0042460

(51) Int. Cl. H01Q 1/36

(52) U.S. Cl. 343/749

(57) ABSTRACT

Disclosed is an antenna using a reactive element that is capable of individually controlling the respective resonance frequencies and resonance bandwidths. The antenna includes a radiator electrically coupled with a feeding point, a first reactive element electrically coupling a first point and a second point of the radiator, and a second reactive element electrically coupling a third point and a fourth point of the radiator. Here, the reactive elements are each coupled to the radiator in parallel, and because of the reactive elements, the antenna is made to have higher-order resonance frequencies that are not integer multiple in relation to a fundamental resonance frequency.

### CROSS-REFERENCE TO RELATED APPLICATION

This application is a continuation of PCT/KR2009/06308 filed Oct. 29, 2009, which claims the benefit of Korean Application Nos. 10-2009-0024654 filed Mar. 23, 2009 and 10-2009-0042460 filed on May 15, 2009, the entire contents of which applications are incorporated herein by reference.

### TECHNICAL FIELD

The present invention relates to an antenna that utilizes a reactive element, more particularly to an antenna in which the reactive element is coupled in parallel to a radiator, so that the resonance frequencies and the relevant resonance bandwidths can be controlled individually.

### BACKGROUND ART

In recent times, the mobile communication device is becoming smaller in size while providing a greater variety of communication services. As such, the mobile communication device is being equipped with an antenna capable of implementing multiple bands and broad bands.

In general, the antenna may employ various current paths or use parasitic radiation elements, etc., to implement multiple and broad bands.

Also, to reduce the size of the antenna, methods may be utilized for increasing the electrical length of the antenna within a limited physical length, for example by implementing the radiator in a meandering or a helical structure.

There is a limit, however, to these methods in providing multiple bands and broad bands while reducing the size of the antenna.

Since an antenna generally has a fundamental resonance frequency and a number of higher-order resonance frequencies that are proportional to the fundamental resonance frequency, it is possible to implement multiple and broad bands and miniaturize the antenna by utilizing these higher-order resonance frequencies as service bands.

However, as these higher-order resonance frequencies are integer multiples of the fundamental resonance frequency, the higher-order resonance frequencies directly could not be utilized as service bands. Thus, there is a need for methods that manipulate higher-order resonance frequencies as service bands in order to implement multiple bands and smaller sizes.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

One objective of the present invention is to provide an antenna which is small in size and with which higher-order resonance frequencies can be utilized as frequencies for service bands.

Another objective of the present invention is to provide an antenna with which the resonance points and resonance bandwidths of the multiple resonance frequencies generated by the antenna can be controlled individually.

To achieve the objectives above, an embodiment of the present invention provides an antenna that includes: a radiator electrically coupled with a feeding point, a first reactive element electrically coupling a first point and a second point of the radiator, and a second reactive element electrically coupling a third point and a fourth point of the radiator. Here, each reactive elements are coupled to the radiator in parallel, and because of the reactive elements, the antenna is made to have higher-order resonance frequencies that are not integer multiple in relation to a fundamental resonance frequency.

Another embodiment of the present invention provides an antenna that includes: a radiator electrically coupled with a feeding point, and a first reactive element electrically coupling a first point and a second point of the radiator. Here, the first reactive element is coupled to the radiator in parallel, and at least one of a resonance frequency and a resonance bandwidth of the antenna varies according to a voltage difference between the first point and the second point or according to current intensity at each of the first and second points.

In an antenna according to an embodiment of the present invention, at least one reactive element is coupled in parallel to the radiator, allowing the antenna to utilize higher-order resonance frequencies as frequencies for service bands. Since multiple bands can be implemented using one radiator, the antenna can be produced in a smaller size.

Also, the antenna makes it possible to individually control the higher-order frequencies and the relevant resonance bandwidths by considering the component types and value of the reactive element and suitably selecting the coupling points. Here, the coupling points can be selected in consideration of the voltage differences between the coupling points and the current intensity at each of the coupling points.

Thus, the antenna according to an embodiment of the present invention can be used to implement smaller sizes and broader bands, as the higher-order resonance frequencies can be controlled individually by selecting the component types, value, and the coupling points of the reactive element.

### BRIEF DESCRIPTION OF DRAWINGS

FIG. 1 illustrates an antenna using reactive elements according to an embodiment of the present invention.

FIG. 2 illustrates the voltage distribution and current distribution of a radiator according to an embodiment of the present invention when the end terminal of the radiator is open.

FIG. 3 illustrates the voltage distribution and current distribution of a radiator according to an embodiment of the present invention when the end terminal of the radiator has a short circuit.

FIG. 4 illustrates an antenna that does not include any reactive elements.

FIG. 5 illustrates an antenna that includes one reactive element which has a capacitance component.

FIG. 6 is a graph of reactance curves.

FIG. 7 is a graph of voltage standing wave ratio curves.

FIG. 8 illustrates radiation patterns for an antenna using a reacting element according to an embodiment of the present invention.

### DETAILED DESCRIPTION OF THE DISCLOSURE

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the drawings, like numerals are used to refer to like components.

When a component is mentioned to be “coupled” or “connected” to another component, this may mean that it is directly coupled or connected to the other component, but it is to be understood that yet another component may exist in-between. On the other hand, when a component is mentioned to be “directly coupled” or “directly connected” to another component, it is to be understood that there are no other components in-between.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

Certain embodiments of the present invention will be described below in detail with reference to the accompanying drawings.

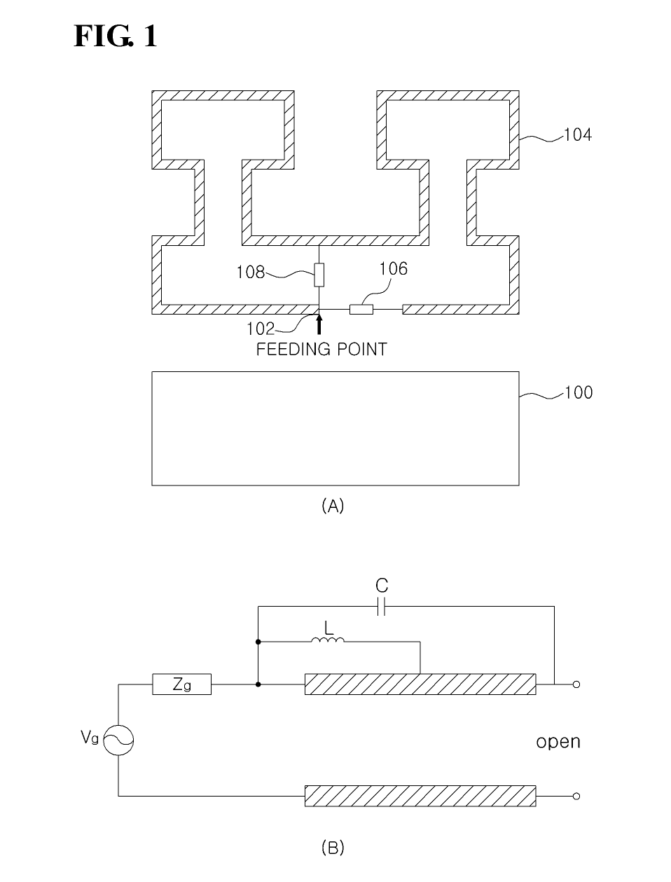

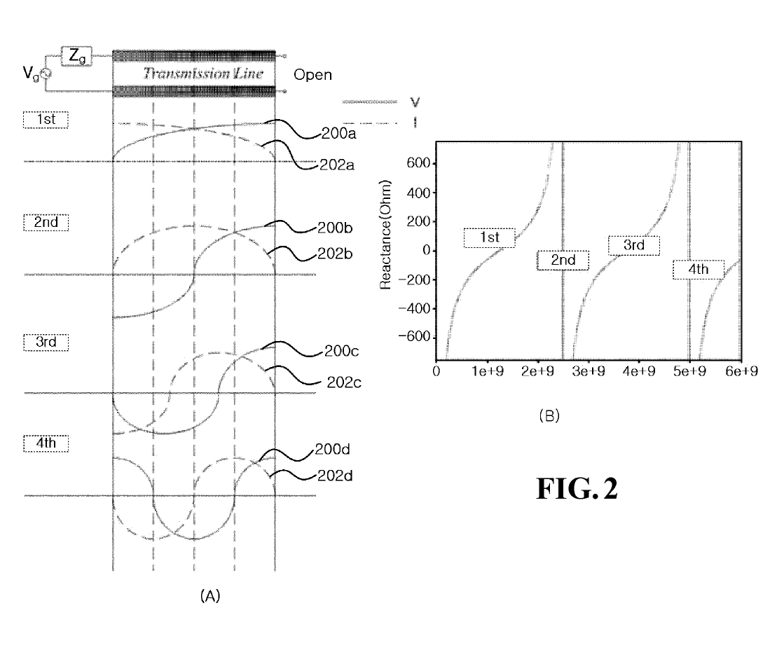

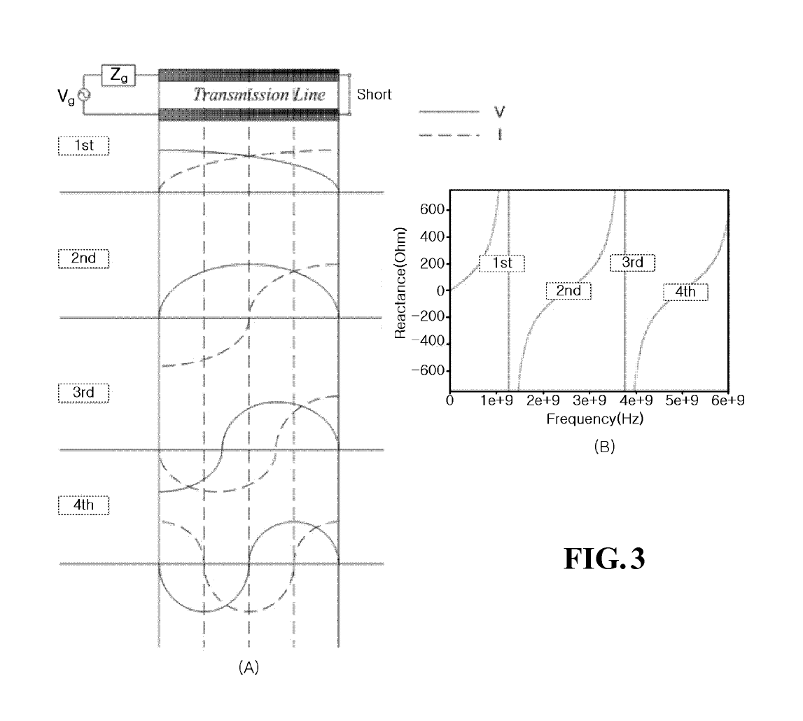

FIG. 1 illustrates an antenna using reactive elements according to an embodiment of the present invention. FIG. 2 illustrates the voltage distribution and current distribution of a radiator according to an embodiment of the present invention when the end terminal of the radiator is open, and FIG. 3 illustrates the voltage distribution and current distribution of a radiator according to an embodiment of the present invention when the end terminal of the radiator is shorted.

Referring to FIG. 1(A), an antenna according to this embodiment can include a ground 100, a feeding point 102, a radiator 104, a first reactive element 106, and a second reactive element 108.

The antenna according to an aspect of the present invention may use at least one reactive element 106, 108 to individually regulate multiple resonance frequencies and the relevant resonance bandwidths, as will be described later in more detail. To be more specific, with the antenna according to an aspect of the present invention, the higher-order resonance frequencies and the relevant resonance bandwidths can be controlled individually by controlling the component and value of the reactive elements 106 and 108 and coupling the reactive elements 106 and 108 to particular positions of the radiator 104.

The feeding point 102 may be the point where a particular amount of electrical power (RF signals) may be fed. For example, an RF transmission line such as a coaxial cable, etc., may be electrically coupled to the feeding point 102, in order to feed a particular amount of electrical power through the RF transmission line to the feeding point 102.

The radiator 104 may be electrically coupled with the feeding point 102 and may output a certain radiation pattern when a particular amount of electrical power is fed through the feeding point 102. Here, the length of the radiator 104 may correspond with the frequency bands used. In the case of a monopole antenna, for example, the length of the radiator 104 can be implemented as ¼ wavelength. Of course, the radiator 104 is not limited to the structure shown in FIG. 1(A) and can be implemented in various forms, such as meandering shapes, linear shapes, spiral shapes, helical shapes, etc. Also, although the illustration in FIG. 1 includes only one radiator 104, other examples can include multiple radiators.

According to an embodiment of the present invention, the end terminal of the radiator 104 can be open, as illustrated in FIG. 1, or can be electrically coupled to a ground. However, the current and voltage distribution of the radiator 104 may vary according to whether the end terminal of the radiator 104 is open or short-circuited, as illustrated in FIG. 2 and FIG. 3, and as a result, the resonance frequency and bandwidth properties of the antenna may be modified. Therefore, a user can open or short the end terminal of the radiator 104 according to design purposes. This will be described later in further detail.

The first reactive element 106 may be coupled, for example, between the input terminal and the end terminal of the radiator 104, as illustrated in FIG. 1(A), to be coupled to the radiator 104 in parallel, as illustrated in FIG. 1(B).

This first reactive element 106 may be a capacitance element, such as a capacitor, etc., or an inductance element, such as an inductor, etc., and may serve to vary the fundamental resonance frequency and the higher-order resonance frequencies, as well as the resonance bandwidths of the antenna. For example, the resonance frequencies of the antenna may be lowered if the first reactive element 106 is a capacitance element, whereas the resonance frequencies of the antenna may be raised if the first reactive element 106 is an inductance element.

The second reactive element 108 may be coupled, for example, between the input terminal (the point where a particular amount of electrical power is inputted) of the radiator 104 and a middle point of the radiator 104, as illustrated in FIG. 1(A), to be coupled to the radiator 104 in parallel, as illustrated in FIG. 1(B). The second reactive element 108 may also be coupled in parallel with the first reactive element 106.

This second reactive element 108 may be a capacitance element or an inductance element. Here, the resonance frequencies of the antenna may be lowered if the second reactive element 108 is a capacitance element, and the resonance frequencies of the antenna may be raised if the second reactive element 108 is an inductance element.

While these reactive elements 106 and 108 can modify the resonance bandwidths of the antenna, the resonance bandwidths may be influenced not only by the reactive elements 106 and 108 but also by the gap between the resonance frequency and the anti-resonance point. This will be described later in further detail.

According to an embodiment of the present invention, the first reactive element 106 can be a capacitance element having a gap form, and the second reactive element 108 can be an inductance element having a helical form. Of course, it is also conceivable to use a chip capacitor for the first reactive element 106 and a chip inductor for the second reactive element 108, instead of structurally implementing the reactive elements.

According to an embodiment of the present invention, the first reactive element 106 can be coupled between the input terminal and the end terminal of the radiator 104, and the second reactive element 108 can be coupled between the input terminal and the middle point of the radiator 104. Consequently, the radiator 104, an inductor (L), and a capacitor (C) may be coupled in parallel, as illustrated in FIG. 1(B). Here, the coupling points of each reactive element 106 and 108 may be selected in consideration of the voltage difference between the coupling points and the electric currents at the coupling points. This is because the voltage difference between the coupling points and the current intensity at the coupling points affect the resonance frequencies and resonance bandwidths. In particular, the resonance frequencies of the antenna may vary the most when the voltage differences between the coupling points of the reactive elements 106 and 108 are the greatest and the currents at the coupling points are all 0.

According to the selection of coupling points, the resonance frequencies and resonance bandwidths of the antenna can be varied as the voltage difference between the coupling points and the currents at the coupling points of each reactive element 106 and 108 are modified.

That is, according to the component types, value, and coupling points of each of the reactive elements 106 and 108, the perturbations of the resonance frequencies may be different. Thus, a user can greatly modify certain resonance frequencies without modifying other resonance frequencies. For example, when low frequencies are desired, using a capacitor can reduce the size of the antenna according to an aspect of the present invention compared to existing antennas. That is, it is possible to obtain a smaller antenna according to an aspect of the present invention. Furthermore, since the resonance bandwidths can be extended using the reactive elements 106 and 108, it is possible to obtain broad bands.

To be more specific, if a capacitance element is coupled to two points where the voltage difference is great for low-frequency resonance and not so great for high-frequency resonance, the low-frequency resonance point can be lowered while the high-frequency resonance point is barely moved at all.

In other words, the resonance frequencies and resonance bandwidths of an antenna based on an aspect of the present invention can be varied according to the component types and value, as well as the voltage difference and current intensity of the coupling points, of the reactive element 106 or 108 coupled in parallel to the radiator 104. In particular, since multiple resonance frequencies can be controlled individually using the reactive elements 106 and 108, as in the example described above, higher-order resonance frequencies other than the fundamental resonance frequency can be utilized as additional service bands for a mobile communication device.

It is also possible to vary the bandwidth by adjusting the gap between a resonance point and an anti-resonance point. Positioning a certain resonance point and a nearby anti-resonance point close together produces narrow band characteristics, whereas positioning a resonance point and a nearby anti-resonance point farther from each other produces broad band characteristics. Using this property, bandwidths can be adjusted by adjusting the anti-resonance point or the resonance point using the inductance element or the capacitance element to alter the frequency characteristics to broad band or narrow band characteristics.

While the example described above is for an antenna based on an aspect of the present invention that includes two reactive elements 106 and 108, it is also conceivable to use one reactive element or three or more reactive elements. That is, the number, component types, value, and coupling method of the reactive elements can be varied, as long as the reactive elements can be used to control the resonance frequencies and resonance bandwidths of the antenna.

A description will now be provided, with reference to the appended drawings, of a method of controlling the resonance frequencies and resonance bandwidths.

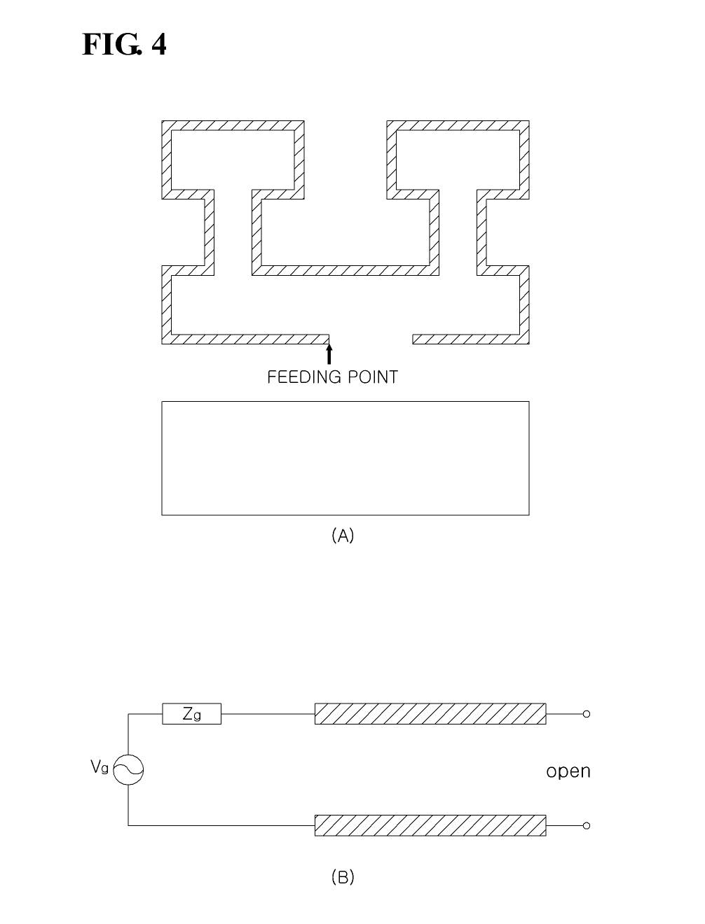

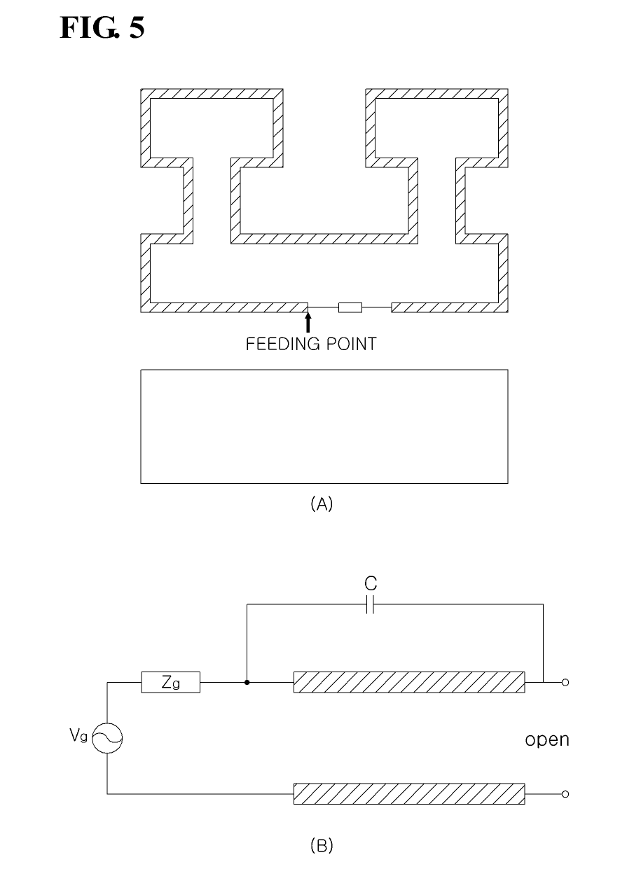

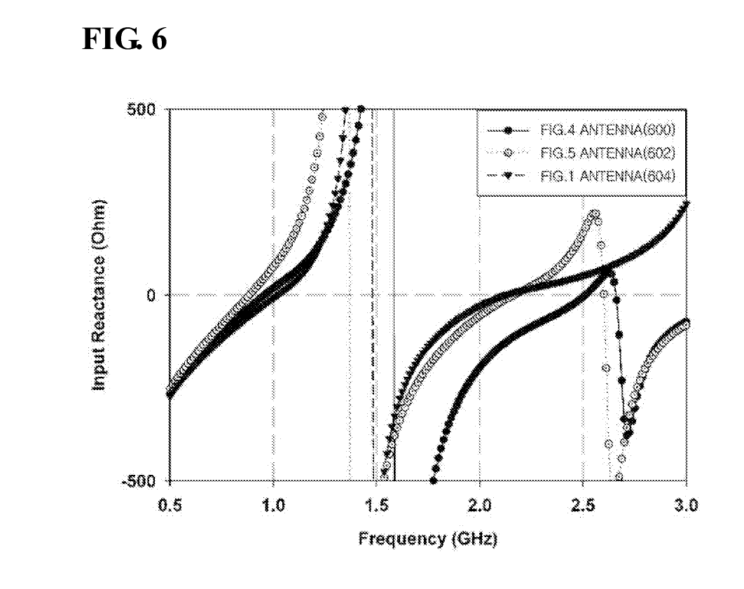

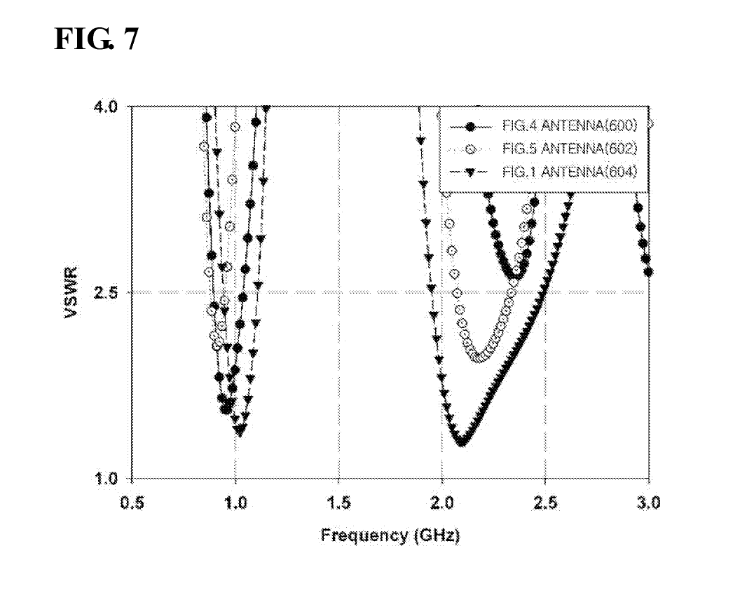

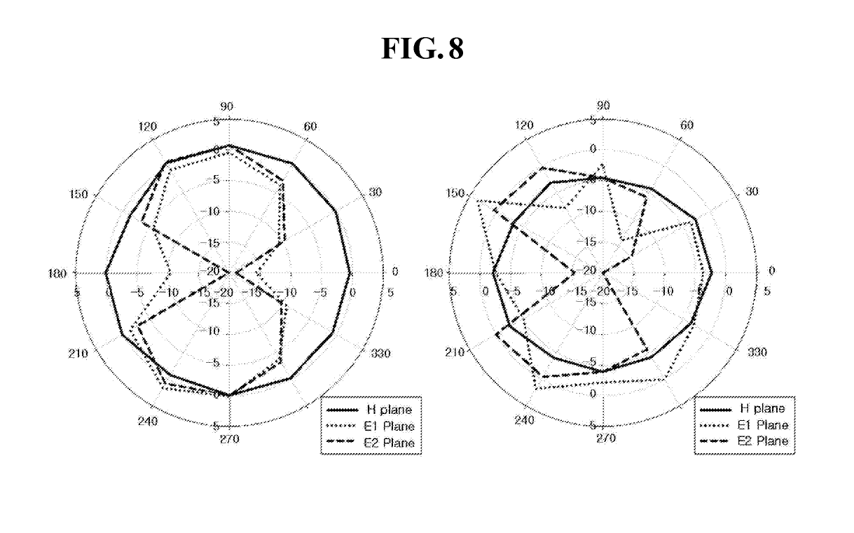

FIG. 4 illustrates an antenna that does not include any reactive elements, and FIG. 5 illustrates an antenna that includes one reactive element which has a capacitance component. FIG. 6 is a graph of reactance curves, and FIG. 7 is a graph of voltage standing wave ratio curves, while FIG. 8 illustrates radiation patterns for an antenna using a reacting element according to an embodiment of the present invention.

The following will examine the reactance characteristics and voltage standing wave ratio (VSWR) characteristics for an existing first antenna 600 that does not include any reactive element, such as that illustrated in FIG. 4, a second antenna 602 that includes only one reactive element having a capacitance component, such as that illustrated in FIG. 5, and a third antenna 604 that includes a first reactive element 106 having a capacitance component and a second reactive element 108 having an inductance component, such as that illustrated in FIG. 1.

It will be assumed that in the antenna 604 of FIG. 1, the first reactive element 106 is coupled between the input terminal and end terminal of the radiator 104 and the second reactive element 108 is coupled between the input terminal and middle point of the radiator 104. Also, it will be assumed that the radiator has a voltage distribution and current distribution substantially similar to those shown in FIG. 2. Furthermore, it will be assumed that the size of the radiator is set to 18 mm×12.5 mm, the distance between the ground and the radiator is set to 5 mm, and the radiator is formed on an FR4 substrate (εᵣ=4.4, thickness 1.6 mm).

Referring to FIG. 6, each of the antennas 600, 602, and 604 has a resonance point formed at a position where the reactance is 0. The first resonance frequency of about 1 GHz, and the third resonance frequency of about 2 GHz, etc., can be used as service resonance frequencies, but the second resonance frequency of about 1.5 GHz is an anti-resonance frequency that cannot actually be used for service. That is, the (2n−1)-th (where n is an integer greater than 1) resonance frequencies are resonance frequencies available for service, while the 2n-th resonance frequencies are anti-resonance frequencies that cannot actually be used.

Based on the above conditions, the actual changes in resonance frequencies and resonance bandwidths will be described as follows. Since each of the antennas 600, 602, and 604 include many resonance points, the changes in frequency and bandwidth will be examined for each resonance frequency.

First, the frequency changes and bandwidth changes at the first resonance frequency will be examined as follows.

In the second antenna 602, a reactive element having a capacitance component is coupled to the input terminal and end terminal of the radiator. Looking at the voltage distribution curve 200a and the current distribution curve 202a for the structure of this second antenna 602, as illustrated in FIG. 2, it is observed that there is a particular amount of voltage difference, albeit not a maximum amount, between the input terminal and the end terminal of the radiator, and that among the coupling points of the radiator, the current at the input terminal is not 0 and the current at the end terminal is 0. Consequently, the resonance frequencies and resonance bandwidths of the second antenna 602 are made different from those of the first antenna 600, due to the reactive element having a capacitance component.

With regards resonance frequency, the first resonance frequency of the first antenna 600 is about 0.85 GHz, whereas the first resonance frequency of the second antenna 602 is about 0.7 GHz, showing that the first resonance frequency of the second antenna is lower than that of the first antenna 600. This may be because the reactive element has a capacitance component. That is, it is seen that coupling a reactive element having a capacitance component in parallel to the radiator may lower the resonance frequency.

With regards resonance bandwidth, the resonance bandwidth of the second antenna 602 is substantially narrower than the resonance bandwidth of the first antenna 600, as illustrated in FIG. 7. This may be because the resonance bandwidth of the second antenna 602 is affected by the reactive element having a capacitance component and the distance to the anti-resonance frequency (the second resonance frequency). To be more specific, the narrow band characteristics may have been obtained as the gap between the anti-resonance frequency, i.e. the second resonance frequency, and the first resonance frequency has been reduced.

Looking at the voltage distribution curve 200b and the current distribution curve 202b for the second resonance frequency, the voltage difference between the coupling points is at a maximum, and the current at each of the coupling points is 0, so that the amount of change of the second resonance frequency is greater than that of the first resonance frequency. Since the reactive element has a capacitance component, the second resonance frequency may move towards a lower frequency. As a result, the gap between the first resonance frequency and the second resonance frequency of the second antenna 602 may be decreased compared to the gap between the first resonance frequency and the second resonance frequency of the first antenna 600, whereby the resonance bandwidth of the second antenna 602 may become narrower. That is, the bandwidth of the second antenna 602 may be substantially narrowed due to the reactive element having a capacitance component and due to the reduced distance to the anti-resonance frequency (the second resonance frequency).

Looking at the reactance curves in FIG. 6, the slope for the second antenna 602 is greater than that for the first antenna 600, i.e. the curve is steeper for the second antenna 602. The steeper the reactance curve, the narrower the bandwidth of the antenna in question.

Thus, when a reactive element is coupled in parallel to the radiator, the resonance frequencies and bandwidths of the antenna may be modified, due to the voltage difference between the coupling points of the reactive element coupled to the radiator and due to the current intensity at the coupling points.

The third antenna 604, as compared to the second antenna, has an additional second reactive element 108, which has an inductance component, coupled between the input terminal and the middle point of the radiator 104. As illustrated by the voltage distribution curve 200a and current distribution curve 202a of FIG. 2, a particular amount of voltage difference occurs between the input terminal and the middle point of the radiator 104, and a particular amount of current exists at each of the coupling points (the input terminal and the middle point). Thus, due to the second reactive element 108, the resonance frequency and resonance bandwidth of the third antenna 604 may be different from those of the second antenna 602.

With regards resonance frequency, the first resonance frequency of the third antenna 604 is about 1 GHz, higher than the first resonance frequency of the second antenna 602. Thus, it is seen that coupling a second reactive element having an inductance component in parallel to the radiator may raise the resonance frequency.

The second reactive element 108 having an inductance component used in the third antenna may thus be used for broadening the resonance band of the third resonance point.

Next, the frequency changes and bandwidth changes at the second resonance frequency, i.e. an anti-resonance frequency, will be examined as follows.

Whereas the second resonance frequency of the first antenna 600 is about 1.7 GHz, the second resonance frequency of the second antenna 602 is about 1.3 GHz, and the second resonance frequency of the third antenna 604 is about 1.5 GHz. Thus, it is observed that using a reactive element having a capacitance component may lower the resonance frequency of the antenna, and that using a reactive element having an inductance component may raise the resonance frequency of the antenna.

Looking at the voltage distribution curve 200b and the current distribution curve 202b for the second resonance frequency, there is a particular amount of voltage difference between the coupling points (the input terminal and the middle point) of the radiator, and the current at the input terminal is 0, while the current at the middle point has a particular amount of intensity. Also, as illustrated in FIG. 2, the voltage difference at the second resonance frequency is greater than that at the first resonance frequency, and the current at the input terminal at the second resonance frequency is 0. Therefore, the resonance frequency of the antenna is varied more greatly at the second resonance frequency compared to the first resonance frequency. As a result, the gap between the first resonance frequency and the second resonance frequency, i.e. the anti-resonance frequency, for the second antenna 602 may be smaller compared to the gap between the first resonance frequency and the second resonance frequency of the first antenna 600. Thus, at the first resonance frequency, the resonance bandwidth of the second antenna 602 may become narrower than the resonance bandwidth of the first antenna 600.

Next, the frequency changes and bandwidth changes at the third resonance frequency will be examined as follows.

In the second antenna 602, the reactive element having a capacitance component is coupled to the input terminal and end terminal of the radiator, and in this case, as illustrated by the voltage distribution curve 200c and current distribution curve 202c of FIG. 2, there is a particular amount of voltage difference between the coupling points (the input terminal and the end terminal) of the radiator, and the current at the input terminal has a particular amount of intensity, while the current at the end terminal is 0. Thus, the resonance frequencies and resonance bandwidths of the second antenna 602 are made different from those of the first antenna 600.

With regards resonance frequency, the third resonance frequency of the first antenna 600 is about 2.55 GHz, whereas the third resonance frequency of the second antenna 602 is about 2.15 GHz, showing that the third resonance frequency of the second antenna is lower than that of the first antenna 600. This may be because the reactive element has a capacitance component.

With regards resonance bandwidth, the resonance bandwidth of the second antenna 602 is broader than the resonance bandwidth of the first antenna 600, as illustrated in FIG. 7. This may be because the gap between the third resonance frequency and the fourth resonance frequency of the second antenna is greater than the gap between the third resonance frequency and the fourth resonance frequency of the first antenna.

That is, as the third resonance frequency of the second antenna 602 is lowered, the bandwidth may conversely be broadened compared to the first antenna 600. As such, the second antenna 602 can implement a broad band while providing a smaller size than that of the first antenna 600.

In the third antenna 604, the second reactive element 108 is coupled between the input terminal and the middle point of the radiator 104. In this case, the currents at the input terminal and middle point of the radiator 104, respectively, are almost maximum, as illustrated by the voltage distribution curve 200c and current distribution curve 202c of FIG. 2, so that the third resonance frequency of the third antenna 604 may be almost unchanged from the third resonance frequency of the second antenna 602 and may be very similar.

That is, the third resonance frequency of the third antenna 604 is about 2.15 GHz, which is very similar to the third resonance frequency of the second antenna 602. With regards resonance bandwidth, the fourth resonance mode shown in FIG. 2 provides maximum voltage differences and 0 currents at the input terminal and at the middle point. That is, the fourth resonance frequency may move towards a substantially higher frequency due to the inductive second reactive element coupled to the third antenna 604 (In FIG. 4, the fourth resonance frequency of the third antenna is beyond the bounds of the graph and thus is not represented.).

As the fourth resonance frequency, which is an anti-resonance frequency, is moved in this manner towards a higher frequency band, the gap between the third resonance frequency and the fourth resonance frequency may be substantially broadened. Therefore, the resonance frequency of the third antenna 604 can be kept similar to that of the second antenna 602, while the bandwidth of the third resonance point can be broader than that for the second antenna.

As such, an antenna according to an aspect of the present invention can individually regulate the resonance frequencies and resonance bandwidths using at least one reactive element, by suitably selecting the component types, values, and coupling points of the reactive elements. In particular, since the antenna can modify the higher-order resonance frequencies to be non-linear in relation to the fundamental resonance frequency, the antenna can obtain multiple bands by utilizing the fundamental resonance frequency and the higher-order resonance frequencies. Moreover, suitable designs for the reactive elements can further be used to accomplish broad bands. Thus, by using the reactive elements described above, the antenna can be made in a smaller size and can obtain multiple bands and broad bands. By arbitrarily regulating the resonance frequencies and bandwidths, a user can readily satisfy a variety of antenna specifications for increased utility.

While the above descriptions were presented for an example in which the end terminal of the radiator is open, a similar operation can also be obtained for examples in which the end terminal of the radiator is short-circuited. Descriptions for such examples will be omitted.

In other embodiments of the present invention, the first reactive element 106 can be implemented as an inductance component, and the second reactive element 108 can be implemented as a capacitance component. That is, various inductance or capacitance can be applied for the reactive elements 106 and 108 according to design purposes.

FIG. 8 illustrates radiation patterns for an antenna using a reacting element according to an embodiment of the present invention. To be more specific, FIG. 8(A) illustrates the radiation pattern for a 1.05 GHz band, and FIG. 8(B) illustrates the radiation pattern for a 2.48 GHz band.

As illustrated in FIG. 8, an antenna according to this embodiment may form an omni-directional radiation pattern, similar to the radiation pattern of a monopole antenna. Thus, the antenna according to this embodiment can be built into a mobile communication device for use.

The embodiments of the present invention set forth above are for illustrative purposes only. It is to be appreciated that those of ordinary skill in the art can modify, alter, and make additions to the embodiments without departing from the spirit and scope of the present invention, and that such modifications, alterations, and additions are encompassed in the appended claims.

1. An antenna comprising:
a radiator electrically coupled with a feeding point;
a first reactive element electrically coupling a first point and a second point of the radiator; and
a second reactive element electrically coupling a third point and a fourth point of the radiator,
wherein the reactive elements are each coupled to the radiator in parallel, and the reactive elements cause the antenna to have higher-order resonance frequencies that are non-linear in relation to a fundamental resonance frequency.

2. The antenna of claim 1, wherein the first reactive element is a capacitance element electrically coupled between an input terminal and an end terminal of the radiator, and
the second reactive element is an inductive element electrically coupled to an input terminal and a middle point of the radiator.

3. The antenna of claim 2, wherein the first reactive element is implemented as a gap structure between the input terminal and the end terminal of the radiator, and the second reactive element is implemented as a helical structure.

4. The antenna of claim 1, wherein a resonance bandwidth of the antenna varies according to voltage differences between coupling points of the reactive elements and according to current intensity at each of the coupling points.

5. The antenna of claim 4, wherein a resonance frequency and a resonance bandwidth of the antenna vary the most when the voltage differences between the coupling points of each of the reactive elements are the greatest and the current intensity at each of the coupling points is 0.

6. The antenna of claim 1, wherein a resonance bandwidth of the antenna is narrower when difference between a relevant resonance frequency and an anti-resonance frequency is smaller and broader when difference is larger.

7. The antenna of claim 1, wherein a resonance frequency of the antenna varies according to a component types and value of each of the reactive elements.

8. The antenna of claim 1, wherein an end terminal of the radiator is open or is electrically coupled with a ground.

9. An antenna comprising:
a radiator electrically coupled with a feeding point; and
a first reactive element electrically coupling a first point and a second point of the radiator,
wherein the first reactive element is coupled to the radiator in parallel, and
at least one of a resonance frequency and a resonance bandwidth of the antenna varies according to a voltage difference between the first point and the second point or according to current intensity at each of the first and second points.

10. The antenna of claim 9, further comprising:
a second reactive element electrically coupling a third point and a fourth point of the radiator,
wherein a resonance frequency and a resonance bandwidth of the antenna vary according to a voltage difference between the third point and the fourth point and according to current intensity at the third point and current intensity at the fourth point.

11. The antenna of claim 10, wherein the first reactive element is a capacitance element electrically coupled between an input terminal and an end terminal of the radiator, and
the second reactive element is an inductive element electrically coupled to an input terminal and a middle point of the radiator.

12. The antenna of claim 11, wherein the first reactive element is implemented as a gap structure between the input terminal and the end terminal of the radiator, and
the second reactive element is implemented as a helical structure between the input terminal and the middle point of the radiator.

13. The antenna of claim 9, wherein a resonance bandwidth of the antenna is narrower when a gap between a relevant resonance frequency and an anti-resonance frequency is smaller and broader when the gap is larger.

14. The antenna of claim 9, wherein a resonance frequency of the antenna varies according to a component types and value of each of the reactive elements.

15. The antenna of claim 9, wherein an end terminal of the radiator is open or is electrically coupled with a ground.

16. An antenna comprising:
a feeding point;
a radiator coupled to the feeding point electrically; and
a reactive element coupling a first point and a second point;
wherein, the reactive element is coupled to the radiator in parallel, and voltage difference between the coupling points is maximum in a specific resonance mode.

17. An antenna comprising:
a feeding point;
a radiator coupled to the feeding point electrically; and
a reactive element coupling a first point and a second point;
wherein, the reactive element is coupled to the radiator in parallel, and current intensity in at least one of the coupling points is zero in a specific resonance mode.

18. An antenna comprising:
a feeding point;
a radiator coupled to the feeding point electrically; and
a reactive element coupling a first point and a second point;
wherein, the reactive element is coupled to at least one point of which current intensity is zero or voltage difference is maximum so that resonance frequency in a specific resonance mode is not in linear relation with fundamental resonance mode.
